(19) United States
(12) Patent Application Publication
(10) Pub. No.: US 2022/0354074 A1
(43) Pub. Date: Nov. 10, 2022

(54) NUTRICULTURE DEVICE

(71) Applicants: AGRI CORE SYSTEM LLC, Minamiuonuma-shi, Niigata (JP); CULTIVERA LLC, Naha-shi, Okinawa (JP)

(72) Inventors: Manabu FUJII, Minamiuonuma (JP); Shohei TOYONAGA, Naha (JP)

(73) Assignees: AGRI CORE SYSTEM LLC, Minamiuonuma-shi, Niigata (JP); CULTIVERA LLC, Naha-shi, Okinawa (JP)

(21) Appl. No.: 17/769,807

(22) PCT Filed: Oct. 22, 2020
(86) PCT No.: PCT/JP2020/039744

§ 371 Date: Apr. 18, 2022

(30) Foreign Application Priority Data
Oct. 29, 2019 (JP) 2019-195848

(51) Int. Cl. A01G 27/00; A01G 13/02

(52) U.S. Cl. CPC A01G 27/003; A01G 13/0268

(57) ABSTRACT

A nutriculture device includes: a culture bed having an upward facing opening; a planting panel that covers the opening of the culture bed, includes a through hole having a crop pass therethrough, and defines an internal space between the cover and the culture bed; a water retention mat inside the internal space and that retains water; a plurality of culture containers each of which supports the crop, each of which is arranged in the internal space, and each of which is provided with a bottom hole; a medium housed in each culture container; a mat-side water irrigation unit feeding water to the water retention mat; and a container-side water irrigation unit feeding water into each of the culture containers per container unit including some of the culture containers or per culture container. The nutriculture device with this configuration can cultivate high-quality crops while suppressing generated drainage water.

### CROSS REFERENCE TO RELATED APPLICATIONS

This application is a U.S. National Phase Application under 35 U.S.C. 371 of International Application No. PCT/JP2020/039744, filed on Oct. 22, 2020, which claims priority to Japanese Patent Application No. 2019-195848, filed on Oct. 29, 2019. The entire disclosures of the above applications are expressly incorporated by reference herein.

### BACKGROUND

### Technical Field

The present invention relates to a nutriculture device for crops.

### Related Art

Conventionally, as a method for cultivating crops, nutriculture in which crops are cultivated using a nutrient solution is known, as well as soil culture in which crops are cultivated on soil. Known as nutriculture are solid medium culture using a solid medium and hydroponic culture in which crops are cultivated by immersing the roots of the crops in a nutrient solution without using the solid medium. Japanese Patent Application Laid-Open No. H5-176641 describes an example of such a nutriculture device.

The device described in Japanese Patent Application Laid-Open No. H5-176641 is a culture device in which two kinds of root of a crop, consisting of a root in a medium (or a root in water) and a root in a humid atmosphere, are generated from the crop, and in which each of the roots is fed with water to cultivate the crop. Such a culture device can make use of the characteristics of these two kinds of root to encourage growth of the crop.

However, in the device described in Japanese Patent Application Laid-Open No. H5-176641, water is fed collectively utilizing a liquid feeding pump to a nutrient solution feeding body (medium) in which a plurality of crops are planted. Therefore, it is difficult to finely control the amount of irrigation water to each crop. For example, it is difficult to feed an amount of water required to each crop in accordance with the variation in transpiration rate of water depending on the difference in planting time, planting position, and cultivation environment of each crop.

As a result, surplus water may adversely affect growth of crops, and an excessive amount of water fed to the crops may lead to drainage water. Suppression of drainage water amount generated at the time of cultivating crops is a world-wide goal from the viewpoint of environmental conservation.

Also, it is generally known that, by applying appropriate water stress on crops by reducing the amount of water fed to the crops, an increase in sugar content and improvement in quality can be expected. However, in a case where the water content around the roots of the crops cannot be adjusted to an appropriate amount, it is difficult to control the water stress on the crops.

Taking such circumstances into consideration thereof, the present invention provides a nutriculture device that can cultivate high-quality crops while suppressing the drainage water generated.

### SUMMARY

(1) A nutriculture device according to an aspect of the present invention includes: a device main body that is provided with an opening which is facing upward and that is formed in a container shape; a cover that is arranged to cover the opening of the device main body, that includes a through hole having a crop pass therethrough, and that is configured to define an internal space between the cover and the device main body; a water retention mat that is provided inside the internal space and that is configured to retain water; a plurality of culture containers each of which supports the crop having passed through the through hole, each of which is arranged in the internal space, and each of which is provided with a connection portion that connects an inside thereof to an outside thereof on an upper side of the water retention mat and on a lower side of the cover; a medium or a nutrient solution that is housed in each of the culture containers; a mat-side water irrigation unit configured to feed water to the water retention mat; and a container-side water irrigation unit configured to feed water into each of the culture containers per container unit including some of the culture containers or per the culture container.

(2) In the nutriculture device described in (1) above, the culture container may include a sidewall portion configured to separate an in-container area inside the culture container from an aerial area outside of the culture container in the internal space.

(3) In the nutriculture device described in (2) above, the container-side water irrigation unit may include: a container water feeding path that has an opening for feeding water to the medium or the nutrient solution inside the culture container; a water sensor configured to measure the amount of water in the in-container area; and a container water feeding control unit configured to adjust the amount of water to be fed from the container water feeding path to the medium or the nutrient solution on the basis of a measurement value of the water sensor to control the amount of water in the in-container area.

(4) In the nutriculture device described in (2) or (3) above, the mat-side water irrigation unit may include: an aerial water feeding path that has an opening for feeding water to the water retention mat; a humidity sensor configured to measure a humidity in the aerial area; and an aerial water feeding control unit configured to adjust an amount of water to be fed from the aerial water feeding path to the water retention mat on the basis of a measurement value of the humidity sensor to control a humidity in the aerial area.

(5) The nutriculture device described in any one of (2) to (4) above may further include an air feeding unit configured to feed air to the aerial area.

(6) In the nutriculture device described in any one of (1) to (5) above, each of the culture containers may be a pot, configured to house the medium and to pass through the through hole, that is put on the water retention mat to be supported by the device main body, and may be provided with a bottom hole, as the connection portion, that penetrates a bottom portion of the pot in an up-down direction.

(7) In the nutriculture device described in (6) above, an upper edge of the pot that is put on the water retention mat may be located further upward than the through hole.

(8) In the nutriculture device described in any one of (1) to (7) above, the water retention mat may include a water retention layer configured to retain water and a surface layer that is stacked on an upper side of the water retention layer and that has moisture permeability and root barrier performance, and the surface layer may be made of a cloth obtained by weaving polyester fibers and may be in an irregular shape on a surface thereof.

(9) The nutriculture device described in any one of (1) to (8) above may further include a heating and cooling unit that is arranged on a lower side of the water retention mat in the internal space, and the heating and cooling unit may include a heat storage body that is arranged between a bottom surface of the device main body and the water retention mat, and a temperature control flow path through which a temperature-controlled liquid that exchanges heat with the heat storage body flows.

(10) The nutriculture device described in (9) above may further include a waterproof sheet configured to separate the water retention mat from the heating and cooling unit.

### Advantageous Effects of Invention

The nutriculture device according to the aspect can cultivate high-quality crops while suppressing generation of drainage water.

### BRIEF DESCRIPTION OF THE DRAWINGS

FIG. 1 is a transversal cross-sectional view of a nutriculture device according to a first embodiment of the present invention.

FIG. 2 is an entire top view of the nutriculture device according to the first embodiment as viewed from above, which is a view as viewed in the direction of the arrow A in FIG. 1.

FIG. 3 is a longitudinal cross-sectional view of the nutriculture device according to the first embodiment, which is a cross-sectional view taken along line B-B in FIG. 2.

FIG. 4 is a top view of a water retention mat of the nutriculture device according to the first embodiment.

FIG. 5 is a perspective view illustrating a method for collecting the roots after the crop is cultivated by the nutriculture device according to the first embodiment.

FIG. 6 is a transversal cross-sectional view of the nutriculture device according to a modification example of the first embodiment of the present invention.

FIG. 7 is a transversal cross-sectional view of a nutriculture device according to a second embodiment of the present invention.

FIG. 8 is an entire top view of the nutriculture device according to a modification example of the first embodiment or the second embodiment of the present invention as viewed from above.

### DETAILED DESCRIPTION

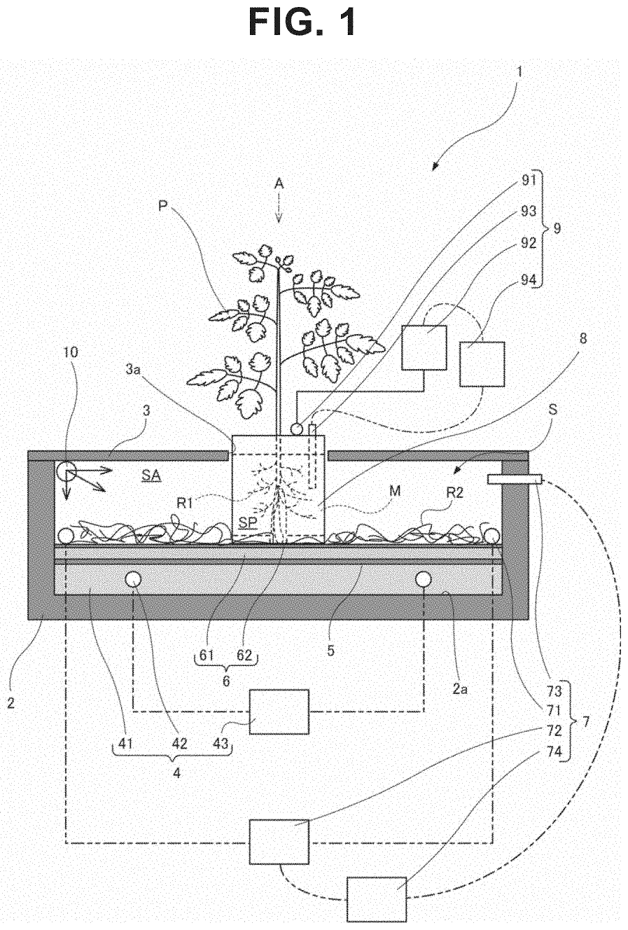

Hereinbelow, embodiments of the present invention will be described with reference to the accompanying drawings. FIGS. 1 to 7 illustrate exemplified embodiments of the present invention.

### First Embodiment

(Entire Configuration)

As illustrated in FIG. 1, a nutriculture device 1 includes: a culture bed (device main body) 2 that is provided with an opening which is facing upward; a planting panel (cover) 3 configured to cover the opening of the culture bed 2; a heating and cooling unit 4, a waterproof sheet 5, and a water retention mat 6 that are provided inside the culture bed 2; a mat-side water irrigation unit 7 configured to feed water into the culture bed 2; a plurality of culture containers 8 that are arranged in the culture bed 2; a medium M that is housed in each of the culture containers 8; a container-side water irrigation unit 9 configured to feed water to the medium M in the culture container 8; and an air feeding unit 10 configured to feed air into the culture bed 2. The nutriculture device 1 is installed in a not-illustrated plastic greenhouse, for example.

(Culture Bed)

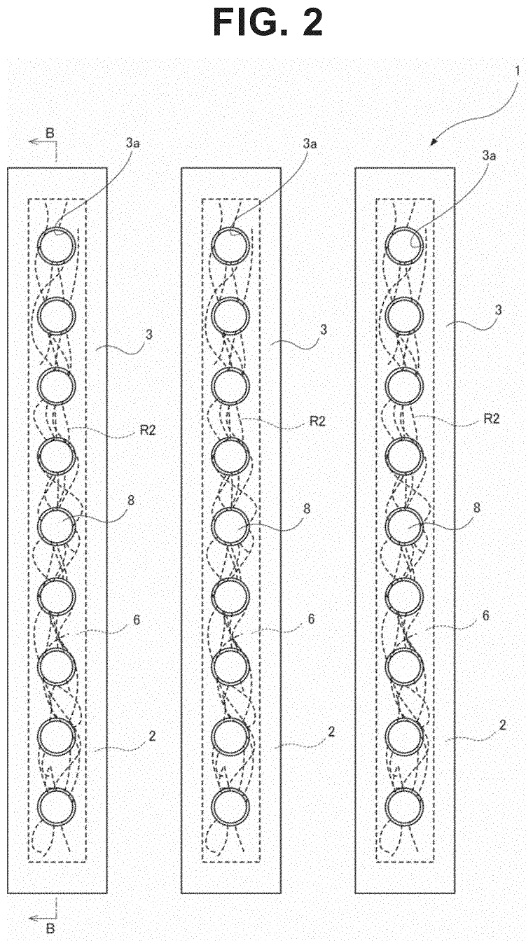

As illustrated in FIG. 1, the upper surface of the culture bed 2 is recessed downward, so that the culture bed 2 is provided with the opening facing upward. Hence, the culture bed 2 is formed in a container shape with a U-shaped cross-section. The material for the culture bed 2 is not particularly limited, but a heat insulating material such as expanded polystyrene may preferably be used. As illustrated in FIG. 2, the culture bed 2 is made to extend in a certain direction (the up-down direction of the drawing sheet of FIG. 1) on a horizontal plane. Also, the plurality of culture beds 2 are arranged to be spaced apart from each other in a traverse direction intersecting with the certain direction.

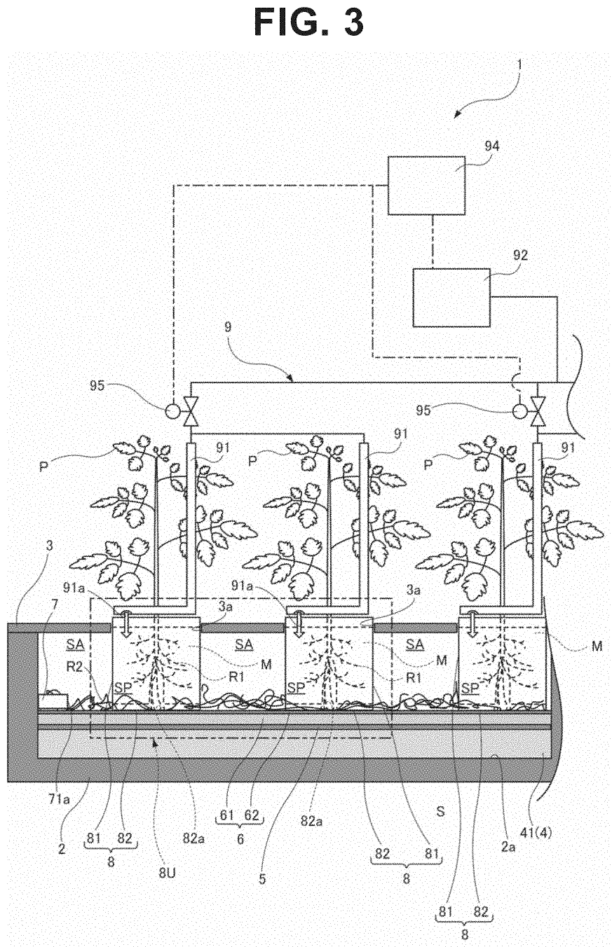

(Planting Panel) Returning to FIG. 1, the planting panel 3 is arranged to cover the opening of the culture bed 2 from above in order to create an internal space S, defined as the space between the planting panel 3 and the culture bed 2. The material for the planting panel 3 is not particularly limited, but a heat insulating material such as expanded polystyrene may preferably be used in a similar manner as in the case of the culture bed. The planting panel 3 is provided with a circular through hole 3a penetrating in the up-down direction. Note that it is unnecessary for the through hole 3a to be circular. The plurality of through holes 3a are provided to be spaced apart equally in the certain direction (see FIGS. 2 and 3).

(Heating and Cooling Unit)

As illustrated in FIG. 1, the heating and cooling unit 4 is installed on a bottom surface 2a inside the culture bed 2 in the internal space S between the culture bed 2 and the planting panel 3. The heating and cooling unit 4 includes a heat storage body 41 provided to cover the bottom surface 2a of the culture bed 2, a temperature control flow path 42 through which a heat medium that exchanges heat between the heat storage body 41 flows, and a temperature control unit 43 configured to control the temperature of the heat medium.

The heat storage body 41 is made of a material, which has a heat storage effect, such as metal or ceramic. The heat storage body 41 is provided to cover the entire bottom surface 2a of the culture bed 2. The temperature control flow path 42 is a pipe or the like provided to run through the heat storage body 41.

The temperature control flow path 42 is made to extend from the inside of the heat storage body 41 toward the outside of the culture bed 2. The temperature control flow path 42 enables the heat medium to pass therethrough. As the heat medium, water is used, for example.

The temperature control unit 43 is provided outside of the culture bed 2. The temperature control unit 43 includes a not-illustrated heat exchanger that heats and cools the heat medium. For example, when temperatures are low in winter, the temperature control unit 43 stores the heat medium that has been heated by means of heat inside the plastic greenhouse, having installed the nutriculture device 1 therein, during sunny periods at which the temperature rises in the plastic greenhouse, or heats the heat medium by means of a heater (not illustrated). Also, when temperatures are high in summer, the temperature control unit 43 cools the heat medium with use of a heat pump or the like. The temperature control unit 43 adjusts the temperature of the heat medium to be at an appropriate level, and flows the heat medium through the temperature control flow path 42 to circulate the heat medium in the heat storage body 41, thereby enabling the heat storage body 41 to be heated or cooled by the heat medium. In this manner, the temperature control unit 43 controls the temperature or the relative humidity inside the internal space S.

(Waterproof Sheet)

As illustrated in FIG. 1, the waterproof sheet 5 is arranged to be stacked on the upper surface of the heat storage body 41 inside the culture bed 2. The waterproof sheet 5 covers the entire upper surface of the heat storage body 41. The waterproof sheet 5 is a sheet made of a resin material such as a vinyl resin or an aluminum metallized film, for example, and has a function of preventing a liquid or moisture from the upper side entering the side provided with the heat storage body 41.

(Water Retention Mat)

As illustrated in FIG. 1, the water retention mat 6 is arranged to be stacked on the upper surface of the waterproof sheet 5 so as to be placed inside the culture bed 2. The water retention mat 6 includes a water retention layer 61 and a surface layer 62 stacked on the water retention layer 61. The water retention layer 61 is provided to be in contact with the upper surface of the waterproof sheet 5. For the water retention layer 61, a non-woven cloth or the like with water retentivity is used, but the material for the water retention layer 61 is not particularly limited. The water retention layer 61 preferably has the ability to retain six or more times as much water as its own weight. The surface layer 62 is a sheet attached to the upper surface of the water retention layer 61 and has moisture permeability (transpiration performance) and root barrier performance.

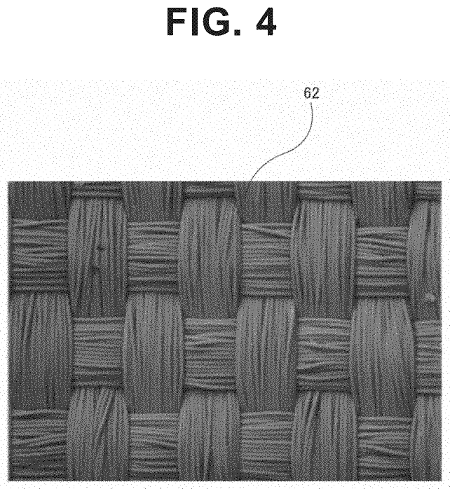

Here, the root barrier performance means performance of inhibiting the roots of a crop P from entering and getting entangled. Note that the surface layer 62 according to the present embodiment does not have to completely prevent the roots from entering and getting entangled with the water retention mat 6 but only requires an increased effectiveness of inhibiting the roots from entering and getting entangled compared to the water retention layer 61. As illustrated in FIG. 4, the surface layer 62 is made of a cloth obtained by weaving polyester fiber materials with a diameter of 10 micrometers or more and 20 micrometers or less, preferably 15 micrometers, and the surface of the surface layer 62 is in an irregular shape. Also, as the surface layer 62 is subjected to a hydrophilic treatment, water retained in the water retention layer 61 exudes from spaces between the fiber materials of the surface layer 62 by capillary action and transpires from the upper surface of the surface layer 62 to the internal space S. Note that the material and structure of the surface layer 62 are not particularly limited. The surface layer 62 may be a microporous film obtained by subjecting a hydrophilic resin film to a micropore perforating treatment, for example. The hydrophilic resin film may not only be a film, such as polyvinyl alcohol (PVA), whose resin itself is hydrophilic, but may also be a film obtained by subjecting a hydrophobic plastic film to a hydrophilic treatment. That is, the surface layer 62 is only required to possess water exudation properties.

(Culture Container)

Returning to FIG. 1, each culture container 8 is inserted in each through hole 3a of the planting panel 3 and is put on the water retention mat 6 and thus arranged in the culture bed 2. As illustrated in FIGS. 2 and 3, the culture containers 8 are arranged to be spaced apart from each other in the certain direction.

In the present embodiment, each culture container 8 is a pot which is opened upward and in which (the seedling of) the crop P has been planted in advance. The outside diameter of the pot is slightly smaller than the inside diameter of the through hole 3a. The outside diameter of the pot and the inside diameter of the through hole 3a may be substantially equal to each other to allow for the pot to be fitted in the through hole 3a, so that the internal space S is completely shielded from the outside of the culture bed 2 and becomes a sealed space. As illustrated in FIG. 3, each culture container 8 is formed in a bottomed cylindrical shape with a cylindrical sidewall portion 81 and a bottom portion 82 provided at the lower end of the sidewall portion 81.

In a state where the culture container 8 is inserted in the through hole 3a, the sidewall portion 81 extends further upward than the planting panel 3, and the upper edge of the sidewall portion 81 is located further upward than the through hole 3a. Consequently, the culture containers 8 divide the internal space S into an in-container area SP inside the culture containers 8 and an aerial area SA outside of the culture containers 8 formed between the culture containers 8 arranged in the certain direction. The in-container area SP is a space in which the below-mentioned medium M is provided while the aerial area SA is a space in which a below-mentioned humid-atmosphere root (a fine root) R2 of the crop P grows.

As illustrated in FIG. 3, the bottom portion 82 is opposed to the surface layer 62 of the water retention mat 6. At the center of the bottom portion 82, a bottom hole 82a penetrating in the up-down direction is provided. The bottom hole 82a is a connection portion which connects the in-container area SP inside the culture container 8 with the aerial area SA outside of the culture container 8. That is, the bottom hole 82a connects the inside of the culture container 8 with the outside thereof on the upper side of the water retention mat 6 and on the lower side of the planting panel 3. The humid-atmosphere root R2 of the crop P extends from the in-container area SP to the aerial area SA through the bottom hole 82a.

(Medium)

Returning to FIG. 1, the medium M is arranged in the in-container area SP inside each of the culture containers 8 to support the crop P. Here, the “medium M” in the present embodiment includes not only a solid medium but also soil. In the medium M, the root (hereinbelow, the root in the medium M is defined as a medium root R1) of the crop grows. For example, the amount of the medium M in each of the culture containers 8 is less than three liters, and more preferably less than one liter.

(Mat-side Water Irrigation Unit)

As illustrated in FIG. 1, the mat-side water irrigation unit 7 includes an aerial water feeding path 71, a water feeding source 72, a humidity sensor 73, and an aerial water feeding control unit 74. The aerial water feeding path 71 is, for example, a tube provided therein with a flow path, is arranged on the upper side of the surface layer 62 of the water retention mat 6, and has an opening 71a (see FIG. 3) to the aerial area SA. The water feeding source 72 is installed outside of the culture bed 2 and is connected to the aerial water feeding path 71. From the water feeding source 72, liquid water (a nutrient solution) containing nutrients is fed to the water retention mat 6 through the aerial water feeding path 71.

The humidity sensor 73 is installed in the culture bed 2. The humidity sensor 73 measures the humidity in the aerial area SA. The aerial water feeding control unit 74 is provided outside of the culture bed 2. The aerial water feeding control unit 74 controls the amount of water to be fed from the water feeding source 72 to the aerial water feeding path 71 according to the measurement value of the humidity sensor 73 so that the humidity in the aerial area SA may be an appropriate value. The aerial water feeding control unit 74 also feeds as much nutrient solution as can be retained in the water retention mat 6, into the aerial area SA, that is, as much nutrient solution as possible without causing any liquid water to exist in the aerial area SA.

(Container-side Water Irrigation Unit)

As illustrated in FIG. 1, the container-side water irrigation unit 9 includes a container water feeding path 91, a water feeding source 92, a water sensor 93, and a container water feeding control unit 94. The container water feeding path 91 is, for example, a tube provided therein with a flow path, is arranged on the upper side of the medium M in each of the culture containers 8, and has an opening 91a (see FIG. 3) for feeding water to the medium M.

As illustrated in FIG. 3, the container water feeding path 91 is provided with an electromagnetic valve 95 corresponding to the culture containers 8. Each electromagnetic valve 95 is provided for each container unit 8U including several culture containers 8 out of all of the culture containers 8. The number of the culture containers 8 included in each container unit 8U and the positions thereof are not particularly limited, but can arbitrarily be selected depending on the difference in the planting time of each crop P and the position of each culture container 8 in the plastic greenhouse, that is, depending on the difference in the transpiration rate of water in each culture container 8. Note that each electromagnetic valve 95 may individually be provided for each culture container 8 although it is not illustrated in the figures. The electromagnetic valve 95 can open and close the container water feeding path 91 and feed water to each culture container 8. The water feeding source 92 is installed outside of the culture bed 2 and is connected to the container water feeding path 91. From the water feeding source 92, liquid water (a nutrient solution) containing nutrients is fed to the medium M of each culture container 8 through the container water feeding path 91.

Returning to FIG. 1, each water sensor 93 is provided for each container unit 8U. That is, the water sensor 93 is provided in any one culture container 8 in the container unit 8U. Note that, in a case where each electromagnetic valve 95 is individually provided for each culture container 8, each water sensor 93 is provided for each culture container 8. The water sensor 93 is inserted in the medium M to measure the water content contained in the medium M. The container water feeding control unit 94 regulates the degree of opening for each of the electromagnetic valves 95 on the basis of the measurement value of each of the water sensors 93 so that an appropriate amount of water may be fed to the medium M of each of the culture containers 8 according to each container unit 8U (for each culture container 8). In this manner, the container water feeding control unit 94 controls the amount of water in the in-container area SP. Note that the container-side water irrigation unit 9 and the mat-side water irrigation unit 7 preferably regulate the humidity so that the humidity in the medium M and the humidity in the aerial area SA may substantially equal to each other.

(Effects)

In the nutriculture device 1 according to the present embodiment described above, the container-side water irrigation unit 9 can adjust the amount of water to be fed to the medium M in each culture container 8 per container unit 8U or per culture container 8. Therefore, it is possible to prevent an excessive amount of water from being fed into the medium root R1 of the crop P, and generation of drainage water can be suppressed. Also, since the amount of water to be fed to the medium root R1 can be adjusted appropriately by the container-side water irrigation unit 9, water stress can be applied to the crop P. This can lead to an increase in sugar content and improvement in quality of the crop P. Furthermore, a situation in which the medium M is left in an excessively humid condition can be prevented, which can reduce the possibility of generating bacteria and pests.

Furthermore, without the necessity of separately installing the partition wall in the culture bed 2, the internal space S between the culture bed 2 and the planting panel 3 can be divided into the aerial area SA and the in-container area SP by the sidewall portion 81 of the culture container 8. Hence, the humid-atmosphere root R2 can be extended in the aerial area SA.

As a result, even in a case where the amount of the medium root R1 is lessened by reduction in the amount of the medium M, the amount of the humid-atmosphere root R2 can be increased by letting the humid-atmosphere root R2 extend inside the aerial area SA, and a required amount of water for the crop P can be secured. Hence, the crop P can be cultivated while the cost can be reduced by reducing the amount of the medium M.

Also, by dividing the internal space S into the aerial area SA and the in-container area SP by means of the culture container 8, extension of the humid-atmosphere root R2 to the outside of the aerial area SA can be prevented. Hence, by managing the humidity inside the aerial area SA by means of the mat-side water irrigation unit 7, the amount of water to be fed to the humid-atmosphere root R2 can be managed appropriately.

Also, the culture container 8 is a pot, and planting the crop P can be done simply by inserting and setting the culture container 8 into the through hole 3a of the planting panel 3. That is, planting can be completed simply by inserting into the through hole 3a the culture container (pot) 8 in which the seedling of the crop P has been planted in advance and putting the culture container 8 on the water retention mat 6, which greatly facilitates the work.

Also, since the crop P is planted simply by putting the culture container 8 on the water retention mat 6, the humid-atmosphere root R2 can grow easily from the bottom hole 82a of the culture container 8 toward the outside of the culture container 8. Since the pot is normally provided with the bottom hole 82a, there is no need to separately form a connection portion for the humid-atmosphere root R2 to pass through the culture container 8, but the bottom hole 82a itself of the pot can function as a connection portion, which can contribute to cost reduction.

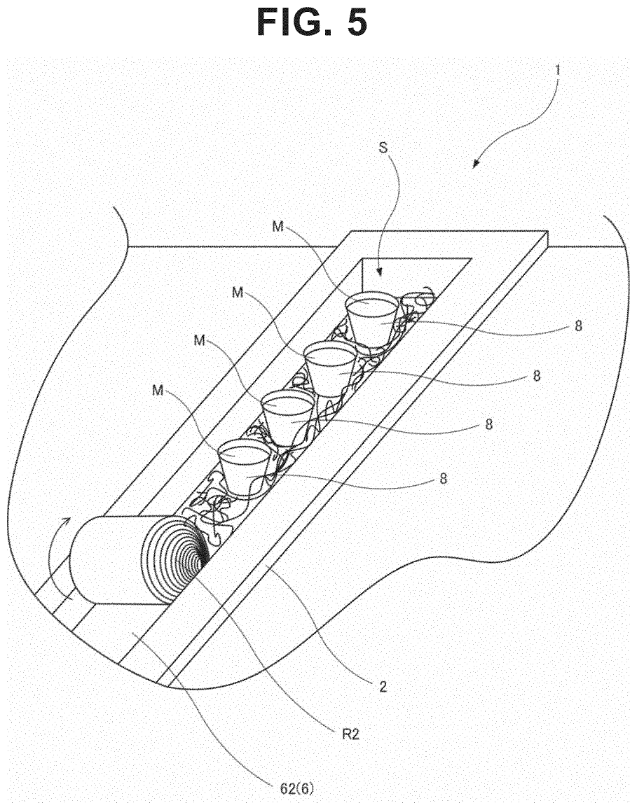

Furthermore, since the water retention mat 6 is installed, the water retention mat 6 can feed water to the humid-atmosphere root R2 in a vaporized state, and no liquid water exists inside the aerial area SA. Therefore, generation of drainage water can be suppressed. Furthermore, since the water retention mat 6 includes the surface layer 62, the surface layer 62 can prevent the humid-atmosphere root R2 from reaching and getting entangled with the water retention layer 61 while enabling water to transpire from the water retention layer 61 of the water retention mat 6 to the aerial area SA. As a result, as illustrated in FIG. 5, after the crop P is harvested, the humid-atmosphere root R2 can be wound and collected separately, and the water retention mat 6 can be reused repeatedly. Thus, the cost can be reduced.

Also, since the heating and cooling unit 4 is provided in the internal space S, the temperatures of the roots R1 and R2 of the crop P can be kept at appropriate levels, and growth of the crop P can be promoted even during the high-temperature period in summer or during the deep-winter period. In the present embodiment, since the heating and cooling unit 4 heats or cools the internal space S indirectly by means of the heat storage body 41, the entire temperature distribution in the internal space S can be made uniform. This is more preferable for growth of the crop P.

Also, the waterproof sheet 5 is interposed between the water retention mat 6 and the heat storage body 41, and the waterproof sheet 5 separates the water retention mat 6 from the heat storage body 41. Thus, it is possible to prevent water from the water retention mat 6 from entering the side provided with the heat storage body 41. This can eliminate the possibility of the heat storage body 41 being heated or cooled by water that has entered the heat storage body 41, and the temperature in the internal space S can be controlled accurately by the heating and cooling unit 4.

Also, since the mat-side water irrigation unit 7 can measure the humidity in the aerial area SA of the internal space S and keep the humidity at an appropriate value, water stress can be applied to the crop P. This can lead to an increase in sugar content and improvement in quality of the crop P.

Furthermore, since the air feeding unit 10 can feed air to the aerial area SA, the crop P can absorb oxygen through the humid-atmosphere root R2 which has an excellent oxygen absorption ability, and growth of the crop P can thus be promoted.

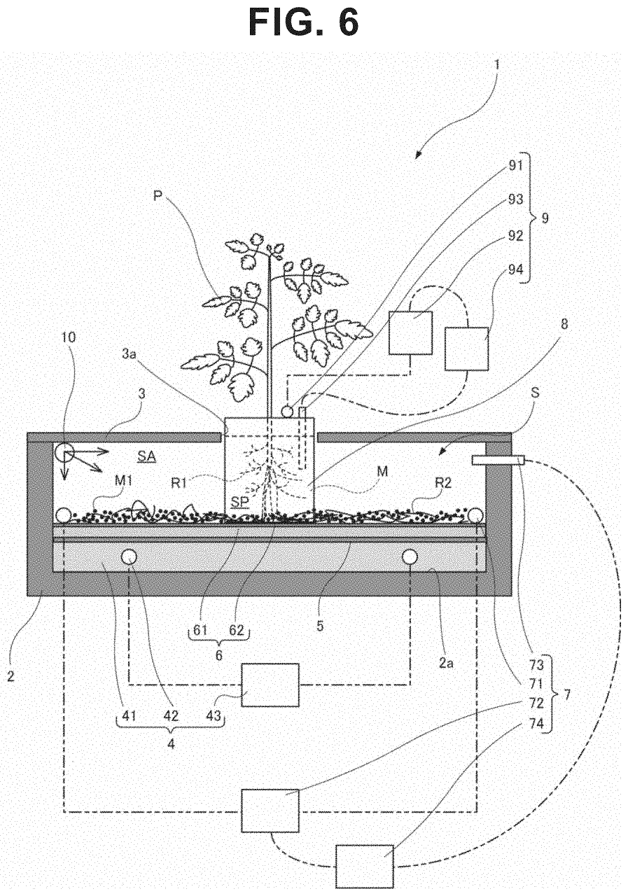

Here, in the present embodiment, as illustrated in FIG. 6, a medium Ml (soil or a solid medium) may be provided on the upper surface of the surface layer 62 of the water retention mat 6. As a result, the humid-atmosphere root R2 becomes entangled with the medium Ml, and growth of the humid-atmosphere root R2 can thus be promoted.

Also, in the present embodiment, although the bottom hole 82a of the culture container 8 is used as a connection portion connecting the aerial area SA to the in-container area SP, a connection portion may be provided in the sidewall portion 81 of the culture container 8 to allow the humid-atmosphere root R2 to extend from the in-container area SP to the aerial area SA.

### Second Embodiment

Next, a nutriculture device 1A according to a second embodiment of the present invention will be described. In the second embodiment, similar components to those in the first embodiment are labeled with the same reference numerals, and a detailed description of the duplicate components is omitted. The nutriculture device 1A according to the present embodiment differs from the nutriculture device 1 according to the first embodiment in that a nutrient solution N, instead of the medium M, is housed (stored) in a culture container 8A.

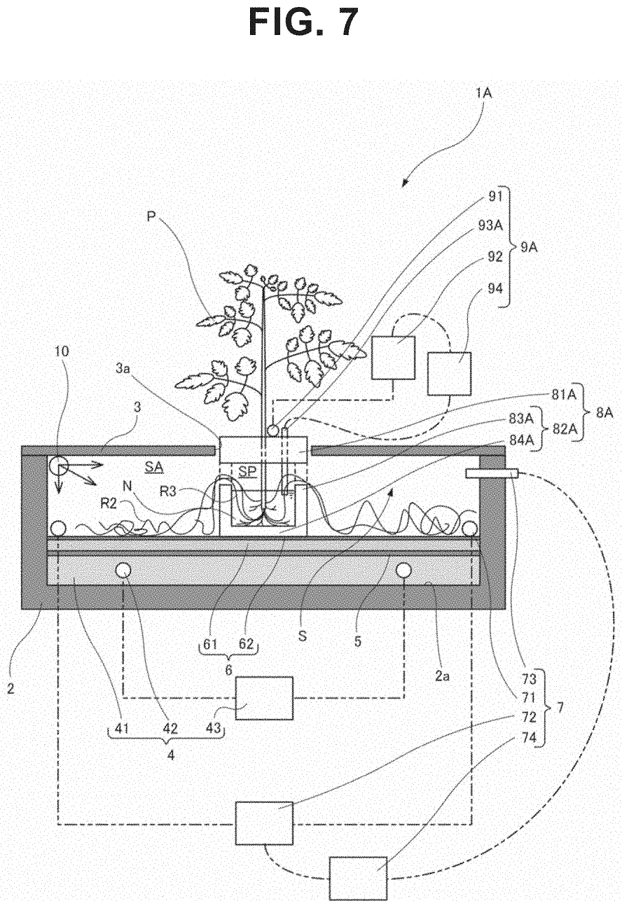

As illustrated in FIG. 7, the culture container 8A includes a top surface portion 81A securing the stem (trunk) of the crop P and a main body portion 82A covered at the upper portion thereof with the top surface portion 81A and formed in a bottomed-cylindrical shape. The main body portion 82A thus includes a sidewall portion 83A and a bottom portion 84A. The sidewall portion 83A is provided with a connection portion 85A penetrating to connect the aerial area SA to the in-container area SP. The humid-atmosphere root R2 extends from the in-container area SP to the aerial area SA through this connection portion 85A. On the lower side of the connection portion 85A, the nutrient solution N is stored in the main body portion 82A. A nutrient-solution root R3 extends in the nutrient solution N.

A water sensor 93A of a container-side water irrigation unit 9A is a water level gauge measuring the water amount (water level) of the nutrient solution N in the main body portion 82A. The water sensor 93A penetrates the top surface portion 81A and is inserted into the main body portion 82A.

(Effects)

Similarly to the first embodiment, in the nutriculture device 1A according to the present embodiment described above, the container-side water irrigation unit 9A can adjust the amount of water to be fed to each culture container 8A per container unit or per culture container 8A. Therefore, it is possible to prevent the nutrient solution N from overflowing out of the culture container 8A, and generation of drainage water can be suppressed. Also, by adjusting the storage amount of the nutrient solution N, water stress can be applied to the crop P, which can lead to an increase in sugar content and improvement in quality of the crop P.

Although the embodiments of the present invention have been described above in detail with reference to the drawings, the respective components and the combination thereof in the above-described embodiments are illustrative only, and addition, omission, substitution, and other modifications of components can be made without departing from the scope of the present invention. Also, the present invention is limited not by the embodiments, but only by the patent claims.

For example, the water retention mat does not have to include the surface layer 62 but may include only the water retention layer 61. Also, as the heating and cooling unit, a heater may be installed inside the internal space S, for example. Also, the waterproof sheet 5 does not necessarily have to be provided.

Also, the air feeding unit 10 does not necessarily have to be provided. In particular, in a case where there is a space between the culture container 8 (8A) and the through hole 3a, air will enter the aerial area SA from this space, and the air feeding unit 10 can thus be dispensed with.

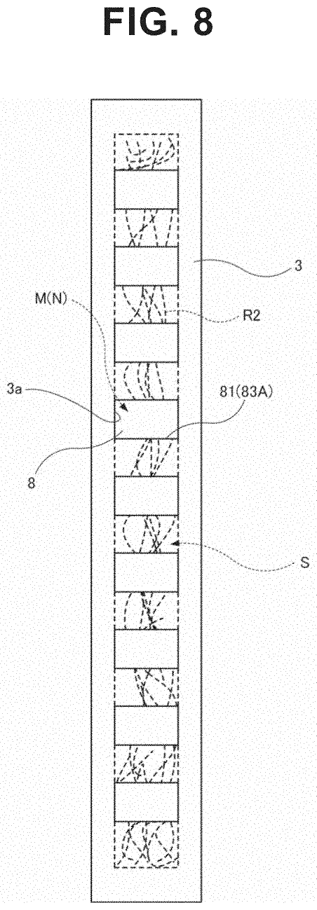

Also, the culture container 8 (8A) may be integral with the planting panel 3. In this case, the medium M or the nutrient solution N is directly put into the through hole 3a of the planting panel 3. Also, in this case, as illustrated in FIG. 8, a sidewall portion 81 (83A) of the culture container 8 may be provided over the entire region in the traverse direction of the internal space S and may be provided to divide the internal space S into a plurality of spaces in the certain direction.

Also, the culture containers 8 do not necessarily have to be arranged to be equally spaced apart in the certain direction. For example, the plurality of culture containers 8 may be arranged at random, or the adjacent culture containers 8 may be arranged to come into close contact with each other. Also, the through hole 3a may be an elongated hole extending in the certain direction, and the plurality of culture containers 8 may be inserted to be arranged in one elongated hole.

Also, instead of the planting panel 3, a cover such as a vinyl film may be used, and the shape, the material, and the like of the cover are not limited as long as the cover can define the internal space S.

### INDUSTRIAL APPLICABILITY

The nutriculture device according to the present invention can cultivate high-quality crops while suppressing generation of drainage water during cultivation.

1. A nutriculture device comprising:
a device main body that is provided with an opening which is facing upward and that is formed in a container shape;
a cover that is arranged to cover the opening of the device main body, that includes a through hole having a crop pass therethrough, and that is configured to define an internal space between the cover and the device main body;
a water retention mat that is provided inside the internal space and that is configured to retain water;
a plurality of culture containers each of which supports the crop having passed through the through hole, each of which is arranged in the internal space, and each of which is provided with a connection portion that connects an inside thereof to an outside thereof on an upper side of the water retention mat and on a lower side of the cover;
a medium or a nutrient solution that is housed in each of the culture containers;
a mat-side water irrigation unit configured to feed water to the water retention mat; and
a container-side water irrigation unit configured to feed water into each of the culture containers per container unit including some of the culture containers or per the culture container.

2. The nutriculture device according to claim 1, wherein the culture container includes a sidewall portion configured to separate an in-container area inside the culture container from an aerial area outside of the culture container in the internal space.

3. The nutriculture device according to claim 2, wherein the container-side water irrigation unit includes:
a container water feeding path that has an opening for feeding water to the medium or the nutrient solution inside the culture container;
a water sensor configured to measure an amount of water in the in-container area; and
a container water feeding control unit configured to adjust an amount of water to be fed from the container water feeding path to the medium or the nutrient solution on a basis of a measurement value of the water sensor to control an amount of water in the in-container area.

4. The nutriculture device according to claim 2, wherein the mat-side water irrigation unit includes:
an aerial water feeding path that has an opening for feeding water to the water retention mat;
a humidity sensor configured to measure a humidity in the aerial area; and
an aerial water feeding control unit configured to adjust an amount of water to be fed from the aerial water feeding path to the water retention mat on a basis of a measurement value of the humidity sensor to control a humidity in the aerial area.

5. The nutriculture device according to claim 2, further comprising an air feeding unit configured to feed air to the aerial area.

6. The nutriculture device according to claim 1, wherein:
each of the culture containers
is a pot, configured to house the medium and to pass through the through hole, that is put on the water retention mat to be supported by the device main body, and
is provided with a bottom hole, as the connection portion, that penetrates a bottom portion of the pot in an up-down direction.

7. The nutriculture device according to claim 6, wherein an upper edge of the pot that is put on the water retention mat is located further upward than the through hole.

8. The nutriculture device according to claim 1, wherein
the water retention mat includes
a water retention layer configured to retain water, and
a surface layer that is stacked on an upper side of the water retention layer and that has moisture permeability and root barrier performance, and
the surface layer is made of a cloth obtained by weaving polyester fibers and is in an irregular shape on a surface thereof.

9. The nutriculture device according to claim 1, further comprising a heating and cooling unit that is arranged on a lower side of the water retention mat in the internal space, wherein
the heating and cooling unit includes
a heat storage body that is arranged between a bottom surface of the device main body and the water retention mat, and
a temperature control flow path through which a temperature-controlled liquid that exchanges heat with the heat storage body flows.

10. The nutriculture device according to claim 9, further comprising a waterproof sheet configured to separate the water retention mat from the heating and cooling unit.
